(19) United States
(12) Patent Application Publication
(10) Pub. No.: US 2025/0226623 A1
(43) Pub. Date: Jul. 10, 2025

(54) COAXIAL ELECTRICAL CONNECTOR

(71) Applicant: Hirose Electric Co., Ltd., Yokohama (JP)

(72) Inventor: Tsubasa KANEKO, Yokohama (JP)

(21) Appl. No.: 18/991,183

(22) Filed: Dec. 20, 2024

(30) Foreign Application Priority Data
Jan. 10, 2024 (JP) 2024-001948

(51) Int. Cl. H01R 24/44; H01R 13/621; H01R 24/52

(52) U.S. Cl. CPC H01R 24/44; H01R 13/6215; H01R 24/52

(57) ABSTRACT

To provide a coaxial electrical connector that makes it easy to ensure excellent signal transmission quality even in broadband mode, the dielectric bodies 30 include a first dielectric body 31 and a second dielectric body 32 provided in such a manner that a space is formed within an offset from said first dielectric body 31 at a location spaced away from the first dielectric body in the direction of connection, the first dielectric body 31 and second dielectric body 32 retain the center conductor 20 in the radial direction, the first dielectric body 31 has a lower dielectric permittivity than the second dielectric body 32, and the second dielectric body 32 has a higher hardness than the first dielectric body 31.

### BACKGROUND

### CROSS-REFERENCE TO RELATED APPLICATIONS

This application claims priority to Japanese Patent Application No. 2024-001948, filed Jan. 10, 2024, the contents of which are incorporated herein by reference in its entirety for all purposes.

### TECHNICAL FIELD

The present invention relates to a coaxial electrical connector.

### RELATED ART

A coaxial electrical connector, in which a dielectric body (insulating member), a center conductor, and an annular fitting are provided within an interior space of an outer conductor, has been disclosed, for example, in Patent Document 1. The interior space of the outer conductor is formed extending through the outer conductor in the up-down direction perpendicular to a mounting face of a circuit board. The dielectric body, which has a tubular configuration and is made of plastic, is disposed within said interior space at a location proximate to the bottom end, and the decoupling of the dielectric body and the center conductor is prevented by virtue of the fact that, after having been inserted into a retaining hole in the dielectric body, the vertically extending center conductor is retained by said dielectric body and, furthermore, the fact that the annular fitting is attached from below.

The center conductor has a beveled protrusion protruding radially outwardly of said center conductor in the section inserted and retained within the retaining hole of the dielectric body, and, in a state wherein the beveled protrusion abuts a stepped portion (indentation) formed in the inner peripheral surface of the retaining hole from below, is supported by the stepped portion from above. When the coaxial electrical connector is mounted to a circuit board, the center conductor, whose bottom end portion slightly protrudes from the bottom face of the outer conductor, is adapted to make contact with circuitry on the mounting face of the circuit board under contact pressure from above, with the up-down direction being the direction of connection. At this time, contact pressure is generated between the center conductor and the circuitry of the circuit board, because while the center conductor is constantly acted upon by a reaction force directed upwardly from the mounting face of the circuit board, the stepped portion of the dielectric body counteracts the above-mentioned reaction force by supporting the beveled protrusion of the center conductor from above.

### PATENT DOCUMENTS

### Patent Document 1

Japanese Published Patent Application No. 2015-149184

### SUMMARY

### Problems to be Solved

According to Patent Document 1, the dielectric body, which is constructed as a single member, has the function of retaining the above-described center conductor as well as the function of generating contact pressure between the center conductor and the circuitry of the circuit board. This dielectric body, which has a tubular configuration extending lengthwise in the up-down direction, is provided so as to fill the space between the inner peripheral surface of the outer conductor and the outer peripheral surface of the center conductor in the radial direction thereof. Consequently, within the vertical extent of the dielectric body, the band of usable frequencies becomes narrower in proportion to the absence of airspace in the above-mentioned radial direction between the inner peripheral surface of the outer conductor and the outer peripheral surface of the center conductor, which causes broadband signal transmission quality in the coaxial electrical connector to be degraded.

With such considerations in mind, it is an object of the present invention to provide a coaxial electrical connector that makes it easy to ensure excellent signal transmission quality even in broadband mode.

### Technical Solution

(1) A coaxial electrical connector connected to an object to be connected in such a manner that the direction of connection is a single predetermined direction, wherein the connector has a metallic outer conductor in which an interior space with an axis extending in the direction of connection is formed extending therethrough in said direction of connection; dielectric bodies directly or indirectly retained within the interior space by the outer conductor; and a metallic center conductor, which extends within the interior space in the direction of connection, is retained by the dielectric bodies, and makes contact with the object to be connected with the help of the front end portion in the direction of connection.

In the present invention, such a coaxial electrical connector is characterized by the fact that the dielectric bodies include a first dielectric body and a second dielectric body provided in such a manner that a space is formed within an offset from the first dielectric body at a location spaced away from the first dielectric body in the direction of connection, the first dielectric body and second dielectric body retain the center conductor in the radial direction, the first dielectric body has a lower dielectric permittivity than the second dielectric body, and the second dielectric body has a higher hardness than the first dielectric body.

In the invention of (1), the first dielectric body and second dielectric body are provided in a spaced relationship in the direction of connection, and a space is formed between the first dielectric body and second dielectric body. This means that within the extent in which this space is formed in the direction of connection, an airspace is present in the radial direction between the inner peripheral surface of the outer conductor and the outer peripheral surface of the center conductor. Therefore, in comparison with the conventional case, in which a single dielectric body extending lengthwise in the direction of connection is provided between the outer conductor and center conductor, the band of usable frequencies can be expanded in proportion to the presence of the above-mentioned airspace without changing the size of the connector, which can ensure excellent signal transmission quality even in broadband mode.

In addition, since in the present invention the first dielectric body has a lower dielectric permittivity than the second dielectric body, the degree to which the band of usable frequencies becomes narrower can be correspondingly minimized by the provision of the dielectric bodies. In addition, since in the present invention the second dielectric body has a higher hardness than the first dielectric body, the retaining force exerted on the center conductor by the second dielectric body can be increased. Therefore, in the present invention, excellent signal transmission quality can be ensured as much as possible even in broadband mode while the center conductor is maintained properly in the standard position.

(2) In the invention of (1), the center conductor may have an abutment portion abuttable against the second dielectric body from the front in the direction of connection. After connecting the coaxial electrical connector towards the front in the direction of connection to the object to be connected, the central conductor may be subjected to a rearwardly directed force exerted by the object to be connected. At this time, the abutment portion of the center conductor abuts the second dielectric body from the front while being subjected to a forwardly directed reaction force exerted by said second dielectric body. Consequently, the above-mentioned rearwardly directed force exerted by the object to be connected is counteracted by this forwardly directed reaction force and, as a result, it becomes easier to maintain the center conductor in the standard position in the direction of connection.

(3) In the inventions of (1) or (2), the first dielectric body may be provided forwardly of the second dielectric body in the direction of connection.

(4) In any of the inventions of (1) to (3), the first dielectric body may be of a smaller dimension in the direction of connection than the second dielectric body. Thus, reducing the dimension of the first dielectric body in the direction of connection makes it possible to correspondingly increase the dimensions of the airspace formed between the first dielectric body and second dielectric body. Therefore, the band of usable frequencies is expanded and, as a result, excellent signal transmission quality can be further ensured even in broadband mode.

(5) In any of the inventions of (1) to (4), the second dielectric body may have a higher deflection temperature under load than the first dielectric body. Thus, when the deflection temperature under load of the second dielectric body is higher, plastic deformation is unlikely to occur even if the environment of use of the coaxial electrical connector becomes hotter. Therefore, the retaining force exerted on the center conductor by the second dielectric body is unlikely to decrease, thereby making it easier to maintain the center conductor in the standard position.

(6) In any of the inventions of (1) to (5), the first dielectric body may be made of polytetrafluoroethylene, and the second dielectric body may be made of polyetherimide.

### Technical Effect

The present invention can provide a coaxial electrical connector that makes it easy to ensure excellent signal transmission quality even in broadband mode.

### BRIEF DESCRIPTION OF THE DRAWINGS

FIGS. 1 (A) and 1 (B) are perspective views illustrating a coaxial electrical connector according to an embodiment of the present invention along with an electronic device, wherein FIG. 1 (A) illustrates a state before being attached to the electronic device, and FIG. 1 (B) illustrates a state after being attached to the electronic device, as viewed obliquely from the rear.

FIG. 2 is a perspective view illustrating the coaxial electrical connector of FIG. 1 (A) as viewed obliquely from the front.

FIG. 3 (A) is a cross-sectional view of the coaxial electrical connector, illustrating a cross-section taken in a plane perpendicular to the transverse direction of the base portion at the location of the axis of the coaxial electrical connector, and FIG. 3 (B) is a cross-sectional view illustrating an enlarged portion of FIG. 3 (A).

FIG. 4 is a partial cross-sectional view of the coaxial electrical connector and electronic device of FIG. 1 (B), illustrating a cross-section taken in a plane perpendicular to the connector width direction, at the location of the axis of the coaxial electrical connector.

FIG. 5 is a cross-sectional view of the coaxial electrical connector according to a variation, illustrating a cross-section taken in a plane perpendicular to the transverse direction of the base portion, at the location of the axis of the coaxial electrical connector.

### DETAILED DESCRIPTION

Embodiments of the present invention are described hereinbelow with reference to the accompanying drawings.

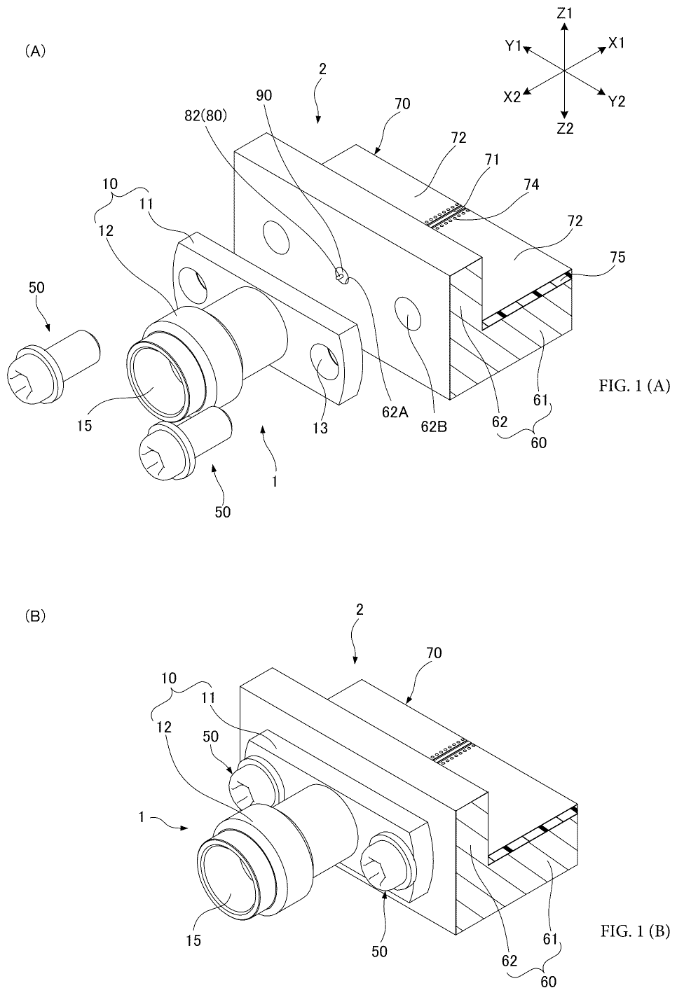

FIGS. 1 (A) and 1(B) are perspective views illustrating a coaxial electrical connector 1 according to an embodiment of the present invention (hereinafter referred to as “coaxial connector 1”) along with an electronic device 2, i.e., the object to be connected, wherein FIG. 1 (A) illustrates a state before being attached to the electronic device 2, and FIG. 1 (B) illustrates a state after being attached to the electronic device 2, as viewed obliquely from the rear. A portion of the electronic device 2 is illustrated in FIG. 1 (A, B). As shown in FIG. 1 (B), the coaxial connector 1 is adapted to be attached to the rear face (face perpendicular to the forward-backward direction) of the electronic device 2 with screws. As a result of attaching the coaxial connector 1 to the electronic device 2 from the rear side (X2 side) in this manner, the coaxial connector 1 is electrically connected to the electronic device 2. This means that the direction of connection of the coaxial connector 1 to the electronic device 2 is the forwardly-oriented direction (X1 direction).

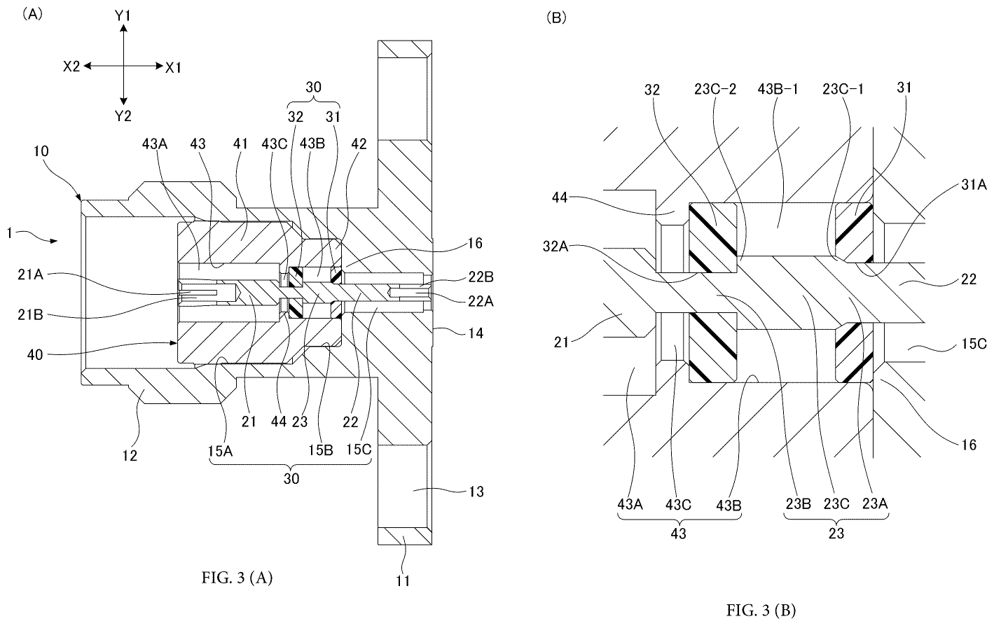

The coaxial connector 1, whose axis extends in the forward-backward direction (X-axis direction), possesses a symmetric geometry in the connector width direction (Y-axis direction), which is perpendicular to both the forward-backward direction (X-axis direction) and the up-down direction (Z-axis direction). The coaxial connector 1 has a metallic outer conductor 10, a metallic center conductor 20 disposed within the hereinafter described interior space 15 of the outer conductor 10 (see FIG. 3 (A)) concentrically with said interior space 15, dielectric bodies 30 made of plastic, and a metallic support 40. In addition, the dielectric bodies 30 include a first dielectric body 31 and a second dielectric body 32 molded from materials different from each other.

The outer conductor 10 has a plate-shaped base portion 11 extending at right angles to the forward-backward direction, and a cylindrical barrel portion 12 of a cylindrical configuration extending rearwardly from the rear face of the base portion 11. As shown in FIG. 1 (A, B), the base portion 11 extends such that the connector width direction is the longitudinal direction thereof, and has a single attachment aperture portion 13, i.e., a screw hole disposed through the base portion 11 in the forward-backward direction, provided at each of the opposite ends thereof sandwiching the barrel portion 12 in the connector width direction. In the present embodiment, screw members 50 are threadedly mated, from the rear, with the attachment aperture portions 13 and screw holes 62B provided in the hereinafter described housing 60 of the electronic device 2 in alignment with said attachment aperture portions 13, thereby attaching the coaxial connector 1 to the housing 60.

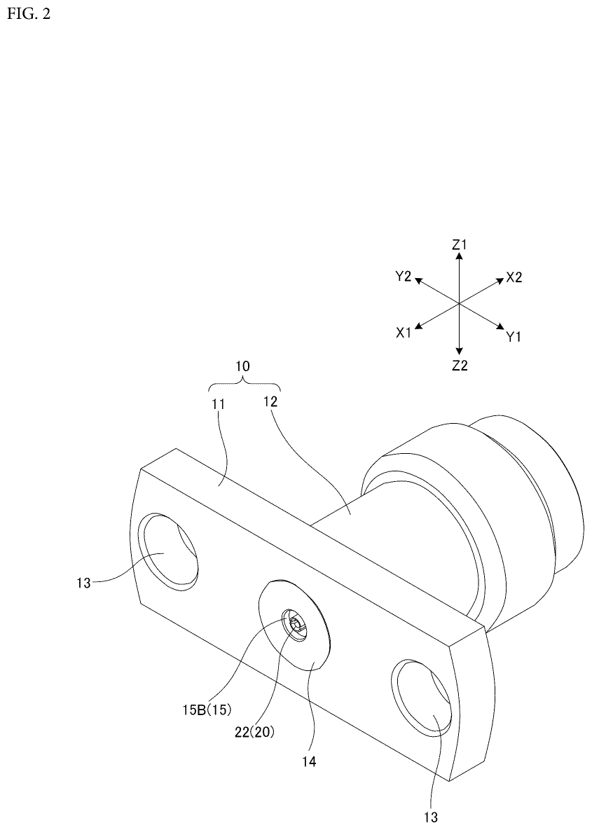

FIG. 2 is a perspective view illustrating the coaxial connector 1 of FIGS. 1 (A) and 1 (B) as viewed obliquely from the front. As shown in FIG. 2, a protrusion 14, which protrudes slightly above other areas, is formed in the area occupying the center on the front face (face on the X1 side) of the base portion 11. When viewed from the front, the protrusion 14 has an annular configuration surrounding the hereinafter described small diameter space 15C (front end portion of the interior space 15). This protrusion 14 is concentric with the center conductor 20 when viewed from the front. In the present embodiment, when the coaxial connector 1 is attached to the housing 60 of the electronic device 2 with screws, the front face of the protrusion 14 is pressed against the rear face of the housing 60. As a result of providing the protrusion 14 on the front face of the base portion 11 in this manner, the outer conductor 10 and the housing 60 are brought into reliable surface contact in the vicinity of the center conductor 20, thereby making it easy to ensure an excellent state of electrical communication.

The barrel portion 12 is of a cylindrical configuration that has an axial centerline extending in the forward-backward direction and extends rearwardly from the rear face of the base portion 11. An intermediate portion of the barrel portion 12 located proximate the rear end in the forward-backward direction has a larger diameter than other parts.

FIGS. 3 (A) and 3 (B), which are partial cross-sectional views of the coaxial connector 1 and the electronic device 2 of FIG. 1 (B), illustrate cross-sections taken in a plane perpendicular to the up-down direction (transverse direction of the base portion 11) at the location of the axis of the coaxial connector 1. As shown in FIG. 3 (A), the outer conductor 10 has formed therein an interior space 15, which has an axial centerline extending in the forward-backward direction and is disposed through the base portion 11 and barrel portion 12 in the forward-backward direction. The interior space 15 has a large diameter space 15A, a medium diameter space 15B, and a small diameter space 15C of respectively different inside diameter dimensions. The large diameter space 15A, medium diameter space 15B, and small diameter space 15C are formed from the rear towards the front in this order and are in communication with each other.

The large diameter space 15A is a cylindrical space formed within a range extending in the forward-backward direction from the location of the rear end to a location proximate to the front end of the barrel portion 12. As shown in FIG. 3 (A), the space in the rear of the large diameter space 15A has a slightly larger diameter than the space in the front. The hereinafter described large diameter portion 41 of the support 40 is accommodated within a portion of the space in the rear and the space in the front. In addition, the space in the rear is a space intended for receiving a counterpart coaxial connector when a counterpart coaxial connector (not shown) is matingly connected to the coaxial connector 1 from the rear. Once the counterpart coaxial connector has been matingly connected, the rear face of the support 40 supported by the outer conductor 10 makes contact with, and is enabled for electrical communication with, the front face of a counterpart outer conductor (not shown) in the counterpart coaxial connector.

As shown in FIG. 3 (A), the medium diameter space 15B, which has a smaller diameter than the large diameter space 15A, is formed within a range extending in the forward-backward direction from the location of the front end of the large diameter space 15A to a location proximate to the front end of the barrel portion 12. The space in the front of the medium diameter space 15B is cylindrical in shape, and the space in the rear portion of the medium diameter space 15B has a tapered configuration whose inside diameter dimension becomes progressively larger as one moves rearward. As shown in FIG. 3 (A), the small diameter space 15C, which is a cylindrical space of a smaller diameter than the medium diameter space 15B, is formed within a range extending in the forward-backward direction from the location of the front end of the medium diameter space 15B to the location of the front end of the base portion 11. A stepped portion 16 is formed at the location of the boundary between the medium diameter space 15B and small diameter space 15C. The stepped portion 16 engages in surface contact with the front face of the support 40 and supports said support 40 from the front. It should be noted that although the stepped portion 16 is adapted to support not only the support 40, but also the hereinafter described first dielectric body 31 from the front, supporting the first dielectric body 31 is not essential.

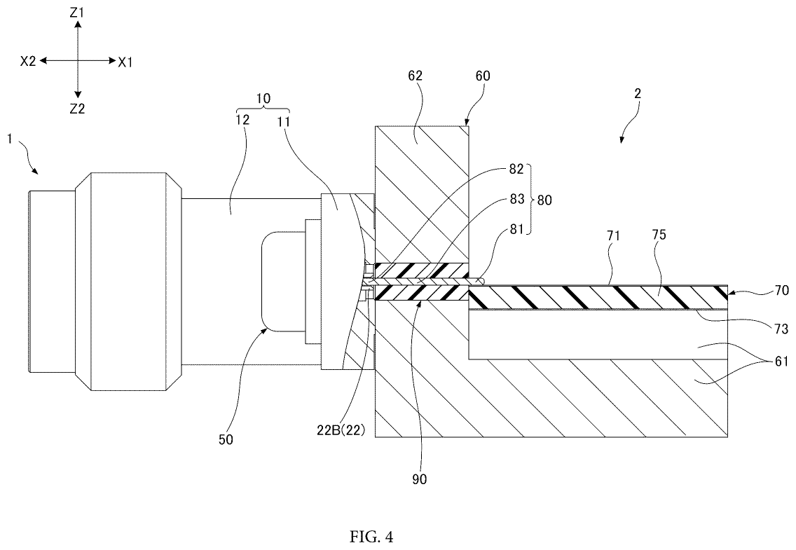

The center conductor 20 is provided extending in the forward-backward direction at a location concentric with the interior space 15 when viewed in the forward-backward direction. As shown in FIG. 3 (A), the center conductor 20 has a connecting portion 21, which is provided in the rear and to which the counterpart center conductor (not shown) of the counterpart coaxial connector is connected, a contact portion 22, which is provided in the front and is capable of making contact with the hereinafter described counterpart center conductor 80 (see FIG. 4) provided in the electronic device 2, and a coupling portion 23, which is provided between the connecting portion 21 and contact portion 22 and couples the two portions.

As shown in FIG. 3 (A), the connecting portion 21 is accommodated within the large diameter space 15A of the outer conductor 10, and more particularly, within the hereinafter described rear space 43A of the support 40 disposed within the large diameter space 15A. The position of the rear end of the connecting portion 21 is aligned with the rear end of the rear space 43A in the forward-backward direction. The connecting portion 21 is female-shaped. Specifically, the rear portion of the connecting portion 21, which is cylindrical in shape and has slits 21A formed at a plurality of locations in the circumferential direction, has connector pieces 21B formed between adjacent slits 21A. The counterpart center conductor (not shown) of the counterpart coaxial connector is adapted to be inserted from the rear into the space enclosed by the plurality of connector pieces 21B. At this time, the plurality of connector pieces 21B are pushed apart radially outwardly of the connecting portion 21 by the counterpart center conductor and assume a resiliently deformed state to make contact with the outer peripheral surface of the counterpart center conductor under contact pressure.

The contact portion 22 has a smaller diameter than the connecting portion 21 and, as shown in FIG. 3 (A), is accommodated within the small diameter space 15C. The position of the front end of the contact portion 22 is aligned with the front end of the small diameter space 15C in the forward-backward direction. The contact portion 22 is female-shaped. Specifically, the front portion of the contact portion 22, which is cylindrical in shape and has slits 22A formed at multiple locations in the circumferential direction, has contact pieces 22B formed between adjacent slits 22A. The counterpart center conductor 80 of the electronic device 2 is adapted to be inserted into the space enclosed by the plurality of contact pieces 22B from the front. At this time, the plurality of contact pieces 22B are pushed apart radially outwardly of the contact portion 22 by the male-type counterpart contact portion 82 provided in the counterpart center conductor 80 (see FIG. 4) and assume a resiliently deformed state to make contact with the outer peripheral surface of the counterpart contact portion 82 under contact pressure.

As shown in FIG. 3 (A), the coupling portion 23, which is accommodated in the hereinafter described front space 43B and intermediate space 43C of the support 40, has three columnar sections of different outside diameter dimensions. Specifically, as shown in FIG. 3 (B), the coupling portion 23 has a first attachment portion 23A located at the front end of the coupling portion 23, a second attachment portion 23B located at the rear end of the coupling portion 23, and an intermediate portion 23C located between the first attachment portion 23A and second attachment portion 23B in the forward-backward direction. When arranged in increasing order of outside diameter dimensions, these columnar sections are the intermediate portion 23C, the first attachment portion 23A, and the second attachment portion 23B. In addition, the first attachment portion 23A has the same diameter as the contact portion 22, and the second attachment portion 23B has a smaller diameter than the contact portion 22. The intermediate portion 23C is of a slightly larger diameter than the contact portion 22 and is of a smaller diameter than the connecting portion 21. The first dielectric body 31 is attached to the outer peripheral surface of the first attachment portion 23A. The second dielectric body 32 is attached to the outer peripheral surface of the second attachment portion 23B.

As shown in FIG. 3 (B), a first abutment portion 23C-1 of a tapered configuration, whose outside diameter dimension becomes gradually smaller as one moves forward, is formed in the section coupled to the front end portion of the intermediate portion 23C, i.e., the first attachment portion 23A. The first abutment portion 23C-1 abuts a tapered surface formed in the inner peripheral surface (described below) of the rear end portion of the first dielectric body 31 by engaging in surface contact therewith from the rear. In other words, the first dielectric body 31 supports the first abutment portion 23C-1 from the front. In addition, as shown in FIG. 3 (B), a second abutment portion 23C-2, which has a stepped configuration at the location of the boundary adjacent to the second attachment portion 23B, is formed in the rear end portion of the intermediate portion 23C. The second abutment portion 23C-2 abuts the front face of the second dielectric body 32 by engaging in surface contact therewith from the front. In other words, the second dielectric body 32 supports the second abutment portion 23C-2 from the rear.

The first dielectric body 31 is made, for example, of polytetrafluoroethylene (PTFE), and is fabricated by molding in an annular plate-like configuration. In the present embodiment, polytetrafluoroethylene, i.e., the material of the first dielectric body 31, has a dielectric permittivity of about 2.1 and a deflection temperature under load of about 55° C. As shown in FIGS. 3 (A) and 3 (B), the first dielectric body 31 is formed slightly smaller in the forward-backward direction, i.e., thinner, than the second dielectric body 32.

The first dielectric body 31, which is formed of an outside diameter that is slightly larger than the inside diameter of the hereinafter described front space 43B of the support 40, is press-fitted and accommodated within the front space 43B. As shown in FIG. 3 (B), the first dielectric body 31 has a first through hole portion 31A extending through the first dielectric body 31 in the forward-backward direction. The first through hole portion 31A is formed of an inside diameter that is slightly smaller than the outside diameter of the first attachment portion 23A of the center conductor 20. This means that the first attachment portion 23A is press-fitted into the first through hole portion 31A.

Although in the present embodiment the first dielectric body 31 has an annular plate-like configuration that is continuous around its entire circumference, as an alternative, for example, a notch portion may be formed at a single location in the circumferential direction. In such a case, the above-mentioned notch portion may be formed such that the first dielectric body 31 is completely severed in the circumferential direction and, in addition, may also be formed partially such that only a portion thereof is severed.

The second dielectric body 32, which is a separate component from the first dielectric body 31, is provided rearwardly of the first dielectric body 31 at a location spaced away from the first dielectric body 31. The second dielectric body 32 is made, for example, of polyetherimide (PEI), and is fabricated by molding in an annular plate-like configuration. In the present embodiment, polyetherimide, i.e., the material of the second dielectric body 32, has a higher dielectric permittivity (about 3.1) than the dielectric permittivity of the first dielectric body 31 and a higher deflection temperature under load (about 197-200° C.) than the deflection temperature under load of the first dielectric body 31. In other words, the first dielectric body 31 has a lower dielectric permittivity and a lower deflection temperature under load than the second dielectric body 32. In addition, the second dielectric body 32 has a higher hardness than the first dielectric body 31. As used herein, the term “hardness” is defined, for instance, as the so-called rebound hardness.

The second dielectric body 32 is formed of an outside diameter that is slightly smaller than the outside diameter of the first dielectric body 31. In addition, the outside diameter of the second dielectric body 32 is equal to the inside diameter of the hereinafter described front space 43B of the support 40. The second dielectric body 32 has a second through hole portion 32A formed through said second dielectric body 32 in the forward-backward direction. The second through hole portion 32A is formed of an inside diameter that is slightly smaller than the outside diameter of the second attachment portion 23B of the center conductor 20. This means that the second attachment portion 23B is press-fitted into the second through hole portion 32A.

In addition, a notch portion (not shown) is formed in the second dielectric body 32 at a single location in the circumferential direction. Therefore, the second dielectric body 32 is rendered discontinuous at the location of the above-mentioned notch portion in the circumferential direction. It should be noted that the above-mentioned notch portion may be formed such that the second dielectric body 32 is completely severed in the circumferential direction and, in addition, may also be formed partially such that only a portion thereof is severed.

The support 40, which has a substantially cylindrical configuration, is accommodated within the interior space 15 of the outer conductor 10. As shown in FIG. 3 (A), the support 40 has a large diameter portion 41 in the rear portion thereof and a small diameter portion 42 in the front portion thereof that is smaller in diameter than the large diameter portion 41. The large diameter portion 41, whose outside diameter is slightly smaller than the space in the front of the large diameter space 15A, is accommodated within said large diameter space 15A. In the present embodiment, the large diameter portion 41, which in the rear end section has a section of a slightly larger diameter than other portions, is press-fitted into the large diameter space 15A and retained by the outer conductor 10 with the help of this section. The small diameter portion 42 has a shape adapted to the medium diameter space 15B. In other words, the front portion of the small diameter portion 42 has a cylindrical configuration, and the rear portion of the small diameter portion 42, i.e., the section coupled to the large diameter portion 41, has a tapered configuration whose outside diameter dimension gradually increases as one moves rearward. The small diameter portion 42, whose outside diameter is slightly smaller than the medium diameter space 15B, is accommodated within said medium diameter space 15B.

An interior space 43, which is coaxial with the interior space 15 of the outer conductor 10 and is disposed through the support 40, is formed in the support 40. As shown in FIG. 3 (A, B), the interior space 43 has a rear space 43A formed within a range that is substantially equal to the large diameter portion 41 in the forward-backward direction, a front space 43B formed within a range that is substantially equal to the small diameter portion 42 in the forward-backward direction, and an intermediate space 43C formed in the vicinity of the boundary of the large diameter portion 41 adjacent to the small diameter portion 42 in the forward-backward direction. The rear space 43A is formed in the rear portion of the interior space 43 and accommodates the connecting portion 21 of the center conductor 20. The front space 43B is formed of a slightly smaller diameter than the rear space 43A in the front portion of the interior space 43 and accommodates the coupling portion 23 of the center conductor 20, the first dielectric body 31, and the second dielectric body 32.

A supporting portion 44 radially inwardly protruding from the inner peripheral surface of the interior space 43 is provided at a location between the rear space 43A and front space 43B in the forward-backward direction. The supporting portion 44 is formed around the entire circumference of the interior space 43, and the space enclosed by this supporting portion 44 constitutes the intermediate space 43C. The intermediate space 43C, which has a smaller diameter than the rear space 43A and front space 43B, accommodates the rear end portion of the coupling portion 23 of the center conductor 20. As shown in FIG. 3 (B), the supporting portion 44, with its front face, engages in surface contact with the rear face of the second dielectric body 32 and supports the second dielectric body 32.

The coaxial connector 1 is manufactured in the accordance with the following procedure. First, the second dielectric body 32 is attached to the second attachment portion 23B by inserting the center conductor 20, at the front end side, i.e., the side of the contact portion 22, through the second through hole portion 32A of the second dielectric body 32. Although in the present embodiment the second through hole portion 32A has a smaller diameter than the contact portion 22 as well as the first attachment portion 23A and intermediate portion 23C of the coupling portion 23, a notch portion is formed in the second dielectric body 32 and, as the contact portion 22 as well as the first attachment portion 23A and intermediate portion 23C are inserted through the second through hole portion 32A, the second dielectric body 32 is deformed to form an opening at the location of the notch portion in the circumferential direction, thereby permitting insertion of the contact portion 22 as well as the first attachment portion 23A and intermediate portion 23C. In addition, in the present embodiment, the second dielectric body 32 is adapted to smoothly form an opening at the location of the notch portion because the first abutment portion 23C-1 has a tapered configuration and therefore, when the second dielectric body 32 passes the location of the first abutment portion 23C-1, the first abutment portion 23C-1 abuts the peripheral surface of the second through hole portion 32A. It should be noted that so long as it is adapted to form an opening at the location of the notch portion when the second dielectric body 32 passes the location of the first abutment portion 23C-1, it is not essential for the first abutment portion 23C-1 to have a tapered configuration and it may have, for example, a stepped configuration.

Further, when the second dielectric body 32 passes the area of the intermediate portion 23C and reaches the area of the second attachment portion 23B, the second dielectric body 32 deforms and closes the opening at the location of the notch portion. As a result, the inner peripheral surface of the second dielectric body 32 engages in surface contact with the outer peripheral surface of the second attachment portion 23B, and the second dielectric body 32 retains the second attachment portion 23B. It should be noted that while in the present embodiment, upon reaching the area of the second attachment portion 23B, the second dielectric body 32 undergoes deformation in a manner to close the opening at the location of the notch portion under the action of its own restoring force, as an alternative, an operator may be tasked with performing the operation of closing the notch portion.

Since in the present embodiment the second attachment portion 23B of the center conductor 20 is formed of an outside diameter that is slightly larger than the inside diameter of the second through hole portion 32A, it is press-fitted into second through hole portion 32A. Therefore, the second dielectric body 32 is subjected to a radially outwardly directed pressure force by the outer peripheral surface of the second attachment portion 23B. In this condition, the notch portion of the second dielectric body 32 is slightly open.

Once the second dielectric body 32 is attached to the second attachment portion 23B, the rear face of the second abutment portion 23C-2 of the center conductor 20 engages in surface contact with, and abuts, the front face of the second dielectric body 32. It should be noted that at this point it is not essential for the second abutment portion 23C-2 to abut the second dielectric body 32, and the second abutment portion 23C-2 may be adapted to abut the second dielectric body 32 and support said second dielectric body 32 from the front only when the coaxial connector 1 is connected to the electronic device 2.

Next, the center conductor 20 having the second dielectric body 32 attached thereto is inserted into the interior space 43 of the support 40 from the front. At this time, the center conductor 20 is inserted until the second dielectric body 32 reaches the rear portion of the front space 43B of the interior space 43. As a result, the coupling portion 23 of the center conductor 20 is accommodated within the front space 43B and the intermediate space 43C. Since in the present embodiment the outside diameter of the second dielectric body 32 is equal to the inside diameter of the front space 43B, the second dielectric body 32, which is subjected to a radially outwardly directed pressure force exerted by the second attachment portion 23B, is subjected to a radially inwardly directed pressure force exerted by the inner peripheral surface of the front space 43B. Therefore, the second dielectric body 32 is compressed in the radial direction and, as a result, the second dielectric body 32 rigidly retains the outer peripheral surface of the second attachment portion 23B with the help of the inner peripheral surface of the second through hole portion 32A.

Although in the present embodiment the second dielectric body 32 is formed of an outside diameter equal to the inside diameter of the front space 43B, as an alternative, the second dielectric body 32 may be formed of an outside diameter that is slightly larger than the inside diameter of the front space 43B. In such a case, the second dielectric body 32 is compressed by a radially inwardly directed pressure force exerted by the inner peripheral surface of the front space 43B, and more rigidly retains the outer peripheral surface of the second attachment portion 23B with the help of the inner peripheral surface of the second through hole portion 32A.

Next, the first dielectric body 31 is attached to the first attachment portion 23A from the front. At this time, the center conductor 20 is inserted, at the front end side, i.e., the side of the contact portion 22, through the first through hole portion 31A of the first dielectric body 31. Since in the present embodiment the first attachment portion 23A is formed of an outside diameter that is slightly larger than the inside diameter of the first through hole portion 31A, it is press-fitted into the first through hole portion 31A. Once attached to the first attachment portion 23A, the first dielectric body 31 engages in surface contact with, and abuts, the first abutment portion 23C-1 from the front. In addition, in the present embodiment, the first dielectric body 31, whose outside diameter is slightly larger than the inside diameter of the front space 43B of the interior space 43, is press-fitted into said front space 43B from the front. Therefore, the first dielectric body 31, in addition to being subjected to a radially inwardly directed pressure force exerted by the inner peripheral surface of the front space 43B, is also compressed under the action of a radially outwardly directed pressure force exerted by the outer peripheral surface of the first attachment portion 23A. As a result, the first dielectric body 31 rigidly retains the outer peripheral surface of the first attachment portion 23A with the help of the inner peripheral surface of the first through hole portion 31A.

With the center conductor 20 and the dielectric bodies 30 accommodated within the interior space 43, the second dielectric body 32, in addition to having its radially inner section supported by the second abutment portion 23C-2 from the front, also has its radially outer section supported by the supporting portion 44 of the support 40 from the rear (see FIG. 3 (B)). It should be noted that at this point it is not essential for the second dielectric body 32 to be supported by the supporting portion 44 from the rear, and the second dielectric body 32 may be adapted to be supported by the supporting portion 44 only when the coaxial connector 1 is connected to the electronic device 2.

Next, the support 40 is press-fitted and accommodated within the interior space 15 of the outer conductor 10 from the rear. The support 40 is press-fitted until the front face thereof abuts the rear face of the stepped portion 16 of the outer conductor 10. As a result, as shown in FIG. 3 (B), the stepped portion 16 engages in surface contact with the respective front faces of the first dielectric body 31 and the support 40, and supports the first dielectric body 31 and the support 40 from the front. In addition, the contact portion 22 of the center conductor 20 is accommodated within the small diameter space 15C. The attachment of the support 40 to the outer conductor 10 in this manner completes the assembly of the coaxial connector 1.

FIG. 4, which is a partial cross-sectional view of the coaxial connector 1 and the electronic device 2 of FIG. 1 (B), illustrates a cross-section taken in a plane perpendicular to the connector width direction at the location of the axis of the coaxial connector 1. As shown in FIG. 1 (A), FIG. 1 (B) and FIG. 4, the electronic device 2 has a metallic box-like housing 60, a circuit board 70 built into the housing 60, and a counterpart center conductor 80 and a counterpart dielectric body 90, which are retained in the hereinafter described attachment portion 62 of the housing 60. As partially shown in FIG. 1 (A) and FIG. 1 (B), the housing 60 has a supporting portion 61, which supports the circuit board 70 from below, and an attachment portion 62, which forms part of the rear wall of the housing 60 and to which the coaxial connector 1 is attached. In the attachment portion 62, a retaining hole 62A for retaining the counterpart center conductor 80 and the counterpart dielectric body 90 is formed through the attachment portion 62 in the forward-backward direction. In addition, in the attachment portion 62, on opposite sides of the retaining hole 62A in the connector width direction (Y-axis direction), screw holes 62B for threadedly mating with screw members 50 are formed extending through the attachment portion 62 in the forward-backward direction.

A signal pattern 71 extending in the forward-backward direction (X-axis direction), and a ground pattern 72 extending in a manner to surround the signal pattern 71 are formed on the mounting face of the circuit board 70 (top face in FIG. 1 (A, B)). As shown in FIG. 4, a counterpart connecting portion 81 forming part of the counterpart center conductor 80, to be described below, is connected to the rear end portion of the signal pattern 71 by soldering, wire bonding, and the like, thereby enabling electrical communication between the signal pattern 71 and the counterpart center conductor 80. In addition, in the present embodiment, the mode of connection of the signal pattern 71 and the counterpart connecting portion 81 is not limited to soldering and wire bonding as described above and may, for example, be adapted to involve simply bringing the counterpart connecting portion 81 into contact with the top face of the signal pattern 71.

In addition, as shown in FIG. 4, a ground pattern 73 is formed on the bottom face of the circuit board 70 within a range comprising the signal pattern 71 and the ground pattern 72 when viewed in the up-down direction. As shown in FIG. 1 (A), a plurality of vias 74 extending through the plastic base material 75 in the up-down direction are formed in a side-by-side arrangement in the forward-backward direction on opposite sides of the signal pattern 71. The ground patterns 72 and 73 are coupled by the vias 74, thereby enabling electrical communication through the medium of said vias 74. In addition, as discussed previously, the circuit board 70 is supported from below by the supporting portion 61 of the metallic housing 60. Consequently, the top face of the supporting portion 61 engages in surface contact with the bottom face of the ground pattern 72, thereby enabling electrical communication between the ground pattern 72 and the supporting portion 61.

The counterpart center conductor 80 extends in the forward-backward direction in a rectilinear configuration and, as shown in FIG. 4, is provided through the attachment portion 62 of the housing 60. The counterpart center conductor 80 has a male-type counterpart connecting portion 81 provided in the front end portion, a male-type counterpart contact portion 82 provided in the rear end portion, and a counterpart coupling portion 83, which is provided between the connecting portion 81 and contact portion 82 and couples the two portions.

As shown in FIG. 4, the counterpart connecting portion 81, which has a pin-like configuration protruding from the front surface of the attachment portion 62 of the housing 60, is in contact with the top face of the rear end portion of the signal pattern 71 of the circuit board 70. As shown in FIG. 4, the counterpart contact portion 82, which has a pin-like configuration protruding from the rear face of the attachment portion 62 of the housing 60, is enabled to contact the contact portion 22 of the center conductor 20 of the coaxial connector 1. The counterpart coupling portion 83, which is disposed within the retaining hole 62A of the attachment portion 62 of the housing 60, has its outer peripheral surface retained by the counterpart dielectric body 90.

The counterpart dielectric body 90, which has a cylindrical configuration with an axis extending in the forward-backward direction, is disposed within the retaining hole 62A of the housing 60 and is retained in the attachment portion 62 while, as described above, retaining the outer peripheral surface of the counterpart coupling portion 83 of the counterpart center conductor 80.

The manner of use of the coaxial connector 1 will be described next. First, the contact portion 22 of the center conductor 20 in the coaxial connector 1 is aligned with the counterpart contact portion 82 of the counterpart center conductor 80, after which the attachment aperture portions 13 of the outer conductor 10 are aligned with the screw holes 62B of the attachment portion 62 of the housing 60 and the connector is disposed on the rear face of the attachment portion 62. The coaxial connector 1 disposed on the rear face of the attachment portion 62 in this manner is attached to the attachment portion 62 as shown in FIG. 1 (B) by threadedly mating screw members 50 with the attachment aperture portions 13 and the screw holes 62B from the rear.

When the coaxial connector 1 is attached to the attachment portion 62, the contact portion 22 of the center conductor 20 receives the counterpart contact portion 82 of the counterpart center conductor 80 from the front. As a result, as shown in FIG. 4, the contact pieces 22B of the contact portion 22 make contact with the counterpart contact portion 82 in a state of resilient deformation. In addition, when the coaxial connector 1 is attached to the attachment portion 62, the front face of the outer conductor 10 is pressed against the rear face of the attachment portion 62. As a result, the outer conductor 10 is rendered electrically continuous with the ground pattern 73 of the circuit board 70 through the medium of the attachment portion 62 and the supporting portion 61, and, furthermore, electrically continuous with the ground pattern 72 of the circuit board 70 through the medium of the vias 74.

In addition, when the coaxial connector 1 is connected to the electronic device 2, the center conductor 20 may be subjected to a rearwardly directed force due, for example, to friction between the contact portion 22 and the counterpart contact portion 82. At this time, the second abutment portion 23C-2 of the center conductor 20 (see FIG. 3 (B)) abuts the second dielectric body 32 from the front while being subjected to a forwardly directed reaction force exerted by said second dielectric body 32. Consequently, the above-described rearwardly directed force is counteracted by this forwardly directed reaction force and, as a result, it becomes easier to maintain the center conductor 20 in the standard position in the forward-backward direction.

In the present embodiment, the first dielectric body 31 and second dielectric body 32 are provided in a spaced relationship in the forward-backward direction and, as shown in FIG. 3 (B), a space 43B-1, which forms part of the front space 43B, is formed between the first dielectric body 31 and second dielectric body 32. This means that within the extent in which this space 43B-1 is formed in the forward-backward direction, that is, within the extent of the intermediate portion 23C of the coupling portion 23 of the center conductor 20, an airspace is present in the radial direction between the inner peripheral surface of the support 40 and the outer peripheral surface of the intermediate portion 23C. Therefore, in comparison with the conventional case, in which a single dielectric body extending lengthwise in the up-down direction is provided between the outer conductor and center conductor, the band of usable frequencies can be expanded in proportion to the presence of the above-mentioned airspace without changing the size of the connector, which can ensure excellent signal transmission quality even in broadband mode.

In addition, since in the present embodiment the first dielectric body 31 is of a smaller dimension in the forward-backward direction (direction of connection) than the second dielectric body 32, the dimensions of the airspace formed between the first dielectric body 31 and second dielectric body 32 can be correspondingly increased. Therefore, the band of usable frequencies is expanded and, as a result, excellent signal transmission quality can be further ensured even in broadband mode.

In addition, since in the present embodiment the first dielectric body 31 has a lower dielectric permittivity than the second dielectric body 32, the degree to which the band of usable frequencies becomes narrower can be correspondingly minimized by the provision of the dielectric bodies 30. In addition, since in the present embodiment the second dielectric body 32 has a higher hardness than the first dielectric body 31, the retaining force exerted on the center conductor 20 by the second dielectric body 32 can be increased. Therefore, in the present embodiment, excellent signal transmission quality can be ensured as much as possible even in broadband mode while the center conductor is maintained properly in the standard position.

In addition, the second dielectric body 32 has a higher deflection temperature under load than the first dielectric body 31. Therefore, the second dielectric body 32 is unlikely to undergo plastic deformation even if the environment of use of the coaxial connector 1 becomes hotter. As a result, the retaining force exerted on the center conductor 20 by the second dielectric body 32 is unlikely to decrease, thereby making it easier to maintain said center conductor 20 in the standard position.

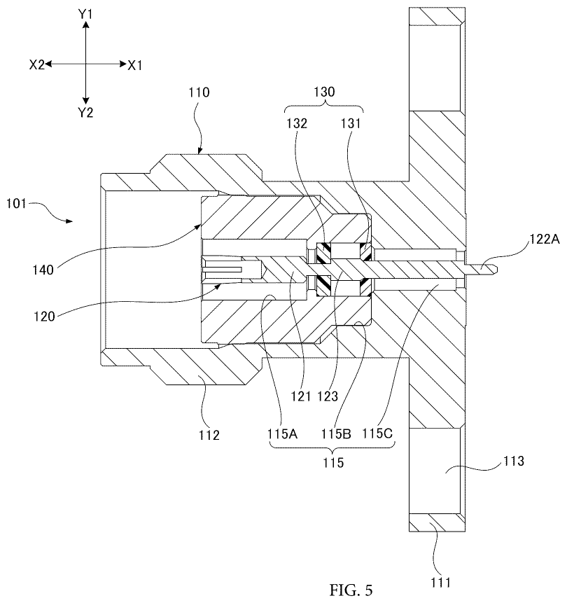

Although in the embodiments previously discussed with reference to FIGS. 1 (A) to 4 the contact portion 22 of the center conductor 20 is female-shaped, the shape of the contact portion admits of a number of variations. FIG. 5, which is a cross-sectional view of a coaxial connector 101 according to a variation of the present embodiment, shows a cross-section taken in a plane perpendicular to the up-down direction (transverse direction of the base portion 111) at the location of the axis of the coaxial connector 101. In FIG. 5, sections that correspond to components in the previously discussed embodiments are indicated with the help of reference numerals obtained by adding “100” to the reference numerals used in the previously discussed embodiments.

As shown in FIG. 5, the configuration of the coaxial connector 101 in this variation differs from the coaxial connector 1 of the previously discussed embodiments in that the contact portion 122 of the center conductor 120 is male-shaped. Specifically, the contact portion 122 is pin-shaped, and the front end portion, which protrudes forwardly of the front face of the base portion 111 of the outer conductor 110, has a contact end portion 122A that is thinner, i.e., of a smaller outside diameter dimension, than other parts in the contact portion 122. When the coaxial connector 101 is connected to an electronic device (not shown), the contact end portion 122A is inserted into a female-type counterpart contact portion provided in the counterpart center conductor (not shown), thereby making contact with said counterpart contact portion. It should be noted that further description of the configuration of each component in the coaxial connector 101, except for the above-described contact portion 122, is omitted herein because the configuration is identical to the corresponding sections in the previously discussed embodiments.

Although in the previously discussed embodiments and variations the dielectric bodies were retained directly by the support, in other words, the dielectric bodies were retained indirectly by the outer conductor through the medium of the support, it is not essential to provide a support and, for example, the dielectric bodies may be adapted to be retained directly by the outer conductor without providing a support.

In addition, in the previously discussed embodiments and variations, although the second dielectric body was provided rearwardly of the first dielectric body, as an alternative, the second dielectric body may be provided forwardly of the first dielectric body. At this time, a second abutment portion is provided in the center conductor at a location that permits abutment against the second dielectric body from the front.

### DESCRIPTION OF THE REFERENCE NUMERALS

1 Coaxial connector
10 Outer conductor
15 Interior space
20 Center conductor
23C-2 Second abutment portion (abutment portion)
30 Dielectric bodies
31 First dielectric body
32 Second dielectric body

1. A coaxial electrical connector connected to an object to be connected in such a manner that the direction of connection is a single predetermined direction, comprising:
a metallic outer conductor in which an interior space with an axis extending in the direction of connection is formed extending therethrough in said direction of connection;
dielectric bodies directly or indirectly retained within the interior space by the outer conductor; and
a metallic center conductor, which extends within the interior space in the direction of connection, is retained by the dielectric bodies, and makes contact with the object to be connected with the help of the front end portion in the direction of connection, wherein:
the dielectric bodies include a first dielectric body, and a second dielectric body provided in such a manner that a space is formed within an offset from the first dielectric body at a location spaced away from the first dielectric body in the direction of connection;
the first dielectric body and the second dielectric body retain the center conductor in the radial direction;
the first dielectric body has a lower dielectric permittivity than the second dielectric body; and
the second dielectric body has a higher hardness than the first dielectric body.

2. The coaxial electrical connector according to claim 1, wherein the center conductor has an abutment portion abuttable against the second dielectric body from the front in the direction of connection.

3. The coaxial electrical connector according to claim 1, wherein the first dielectric body is provided forwardly of the second dielectric body in the direction of connection.

4. The coaxial electrical connector according to claim 1, wherein the first dielectric body is of a smaller dimension in the direction of connection than the second dielectric body.

5. The coaxial electrical connector according to claim 1, wherein the second dielectric body has a higher deflection temperature under load than the first dielectric body.

6. The coaxial electrical connector according to claim 1, wherein the first dielectric body is made of polytetrafluoroethylene and the second dielectric body is made of polyetherimide.
